(19) United States
(12) Patent Application Publication
(10) Pub. No.: US 2008/0003552 A1
(43) Pub. Date: Jan. 3, 2008

(54) Method of teaching writing

(76) Inventor: Christina Supe, Fullerton, CA (US)

Correspondence Address: MICHAEL A. SHIPPEY, PH. D., LAW OFFICES OF KARLA SHIPPEY, 4848 LAKEVIEW AVENUE, SUITE E, YORBA LINDA, CA, 92886, US

(21) Appl. No.: 11/476,537

(22) Filed: Jun. 28, 2006

(51) Int. Cl. G09B 11/00

(52) U.S. Cl. 434/162

(57) ABSTRACT

Described is a novel method for teaching narrative and expository writing, reflecting the understanding that writing is a repetitive process and is a successful means of communication only if the writing is proficient. The method trains teachers to teach successful writing to students through four stages (modeled, shared, guided, independent), and these same stages are used in the teacher training. This method focuses on the planning aspects necessary for successful writing by identifying the essential elements of the application, requiring students to notate the details before writing sentences, and emphasizing the importance of revising the content of the composition. Of primary importance to this method is that the students identify and understand the rubric that will be used to score their writing, and they can revise and adjust theirs to comply with the rubric.

### FIELD OF INVENTION

The present invention is directed to a method of teaching writing, and more particularly, to a method of teaching narrative and expository writing that is designed to improve the ability of students to communicate successfully through writing. The method encompasses the training of teachers in the instruction of writing and the training of students in the writing of narrative and expository compositions.

### BACKGROUND OF INVENTION

Writing instruction in elementary and secondary school curriculum tends to consist of giving students a topic and telling them to write a certain number of words or sentences about it. At the early educational stages, there is no focused planning of a narrative (story) or expository composition and no emphasis on understanding how to communicate successfully in a writing. While there is a natural story-telling ability in most children, evidenced by their ability to relate a story orally, this ability has not been used in the instruction of writing.

Much prior art has been devoted to the improvement of methods for teaching reading, not writing. Examples include U.S. Pat. No. 6,869,287, which claims a method of teaching reading that prevents or eliminates problems in reading related to the various functions of neural networks. Other prior art has focused on the grammatical aspects of teaching writing, such as U.S. Pat. No. 4,419,080, which discloses an apparatus and method using speech cards to learn the parts of speech.

No prior art has been found that teaches a method of instructing and learning to write narratives and expository compositions that successfully communicate their purpose to the reader. The functions and parts of a writing can be analyzed, broken down, charted, set into trees, labeled, and memorized over and over again, but writing is not successful unless and until the composition becomes interesting and memorable to the reader. This invention consists of a method of training teachers and students to understand, analyze, plan, write, revise, and publish a successful narrative or expository composition.

### SUMMARY OF INVENTION

This invention is a method for training students to write successful narratives and expository compositions, meaning compositions that successfully communicate to the reader because the text is interesting and memorable. This method can be used to teach the writing of narratives, expository writings, and responses to literature. The invention consists of two core elements: training for teachers and training for students. In the absence of either of these elements, this method of training will fail. These core elements are each broken down into four stages of learning: modeled, shared, guided, and independent.

This method is uniquely innovative. First, the core elements of this invention have been carefully constructed to be similar to each other, which clarifies the structure and, therefore, the application of the method. In other words, the training for teachers is performed using similar stages to the training for the students.

A unique feature is that this training method uses a “complete modeling” approach with the training conducted in stages beginning with a verbalized modeling by the teacher of the entire writing process. In this way, the students understand each part of the writing process completely before they are asked to write independently.

Yet another innovative feature of this training method is the fact that the students are provided with the rubric used to score their writing. This method emphasizes student responsibility for checking their writing against the known rubric. With the rubric provided, the students can know the specific standards that they must meet in their writing. This method strongly encourages students to pass the writing requirements by giving them all the standards they need to avoid failure.

It is an object of this method to train teachers to teach writing by means of modeling and guiding the process.

It is an object of this method to teach students writing by means of modeling and guiding the process.

It is an object of this method to identify the core elements of narrative and expository writing using a constant plan that begins with a few basic elements and continues to add elements, building more complex writing as students gain facility in the basic elements.

It is an object of this method to encourage students to succeed in narrative and expository writing by critically analyzing their own writing in comparison to the rubric used to score their writing by standardized testing authorities.

It is a further object of this method, and an innovative feature of it, to provide a method of narrative and expository writing that can be learned and applied efficiently in the typically short amount of time allowed in schools to master these applications.

Yet another object of this method is to provide a method of training narrative and expository writing that can be adjusted and adopted for different ages and grade levels without significant alteration of the basic stages and elements used in the method, allowing for consistency from year to year despite the fact that students will have new teachers and even schools as they progress from grade to grade.

### BRIEF DESCRIPTION OF DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flowchart showing the basic stages of the Teacher Component and Student Component of this method, having a chart for comparison of the features of each stage.

FIG. 2 is a flowchart representing the Student teaching component of this method.

FIG. 3 is one preferred embodiment of the writing plan in its basic form.

FIG. 4 is another preferred embodiment of the writing plan in a more developed form.

FIG. 5 is a third preferred embodiment of the writing plan, using icons to promote learning.

FIG. 6 is an illustration of a handwritten writing plan that can be used for planning a fictional narrative writing.

FIG. 7 is a flowchart representing the completion of the Student Component of this method.

FIG. 8 is a flowchart representing the Teacher Component of this method.

FIG. 9 is a flowchart representing the sub-elements of the training method for teachers.

FIG. 10 is a flowchart representing the sub-elements of the process for setting the curriculum of the training method.

### DESCRIPTION OF INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

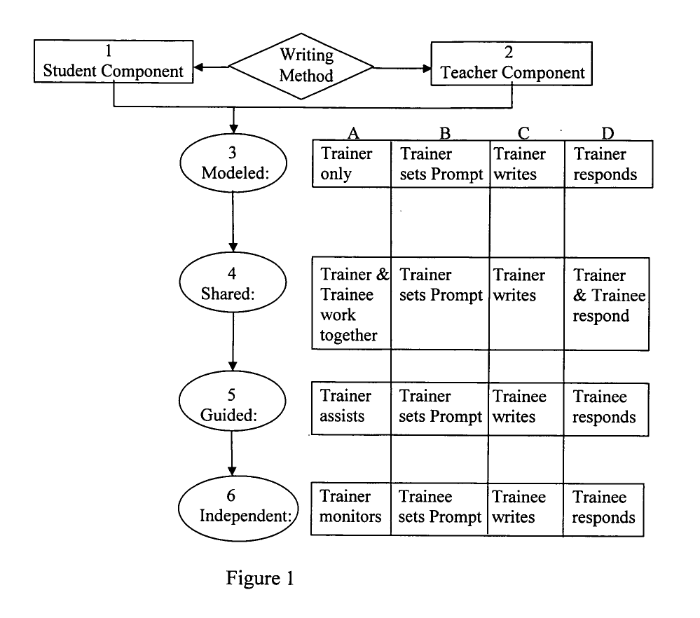

Referring to FIG. 1, the flowchart shows that this method of teaching writing is divided into two core elements: training for teachers 2 and training for students 1. It is understood that these terms are being used in a broad sense, such that this training may be used in various educational forums. Its preferable usage has been in the training of school age children (K-12^{th}) and of educators who work with children of those ages. Of course, teachers who are learning the method could be called “students” and those students who learn the method might later train others, becoming “teachers.” To avoid confusion in terms when describing similarities of the two core two elements, this description additionally uses the term “trainer” to refer to any person who is using this method to train others, whether the trainees are teachers or younger students. Those who are being trained are referred to as “trainees.”

The primary components of the two core elements are illustrated in FIG. 1. Regardless of whether the method is used to train teachers 2 or students 1, there are four stages. These stages are Modeled Writing 3, Shared Writing 4, Guided Writing 5, and Independent Writing 6.

The major features of these stages are also illustrated in this FIG. 1 by using a comparative chart. It can be seen that the role of the trainer is initially strong, if not monopolizing, when the training commences at the Modeled Writing Stage 3. The trainer acts with minimal, if any, trainee input 3A in the writing process, thus serving as a role model for the trainee to understand the writing process before being allowed to write. The trainer will set the Prompt of the writing 3B, create the writing 3C, and respond to self-given instructions 3D.

At the Shared Writing Stage 4, the trainer begins to allow more trainee participation. The trainer encourages the trainees to work through the writing method with the trainer 4A and to respond to the instructions 4D, although the trainer retains authority over the Prompt 4B and writing 4C.

In Guided Writing 5, the trainer still selects the Prompt 5B, but gives the trainees more time on their own to write 5C and to respond to instructions 5D. Having seen the trainer model the method of writing, the trainees at the Guided Writing Stage have become studious in their approach to writing. While still needing some guidance 5A, they have an understanding of the significance of what they are learning and how it is perceived as superior work by others.

Finally, in Independent Writing 6, trainees have matured as writers and become capable of setting their own Prompts 6B, writing their own narratives and expository compositions 6C, and responding to the instructions with minimal, if any, assistance from the trainer 6D. At this stage, the trainer is merely a monitor of the process 6A.

A significant innovative factor in this method is the fact that it can be learned and applied efficiently in the typically short amount of time allowed in schools to master story and report writing. The reason is that the method consists of the four stages shown in FIG. 1, and these stages do not change and can be applied over and over again to introduce new elements into the narrative and expository writing processes.

The method can be used to provide consistency in curriculum taught year after year by simply adding the appropriate grade-level testing standards into the writing process.

When used to train teachers, the instruction period is typically one or two days, preferably with “hands-on” experience in a classroom with a teacher who is proficient in the method.

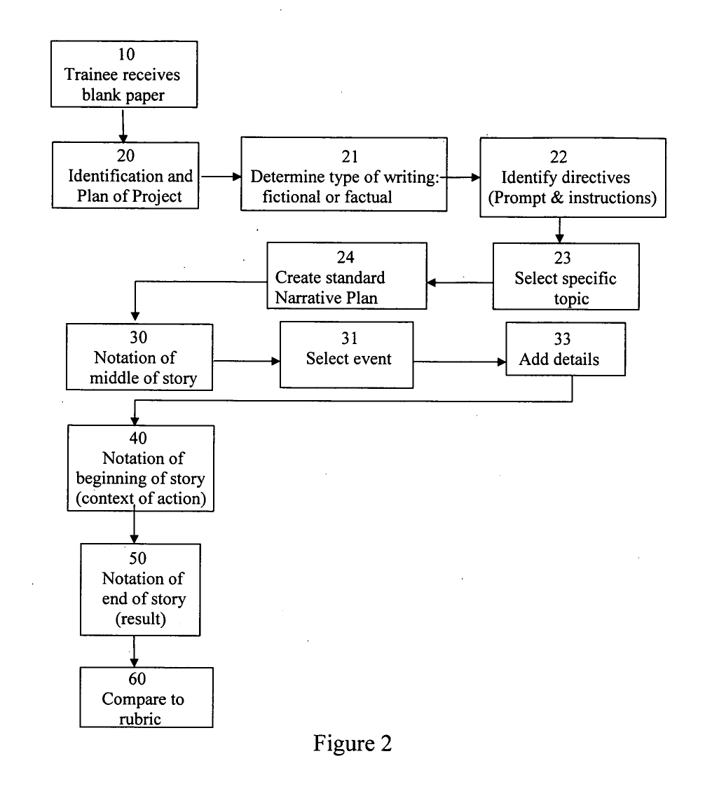

FIG. 2 is a flow chart representing the Student Component of this method. This is the basic method for teaching students per the current invention. The sequence of the Student Component will be the same regardless of which of the four Stages (Modeled, Shared, Guided, Independent; see FIG. 1), is being taught. Of course, the extent of involvement of the trainees at each step of the sequence will differ as the stages proceed from the trainer serving as a role model at the Modeling Stage, through increasing trainee participation in the Shared and Guided Stages, until finally the trainer is merely monitoring the trainee's activities in the Independent Stage.

In all Stages, the Student Component commences with the trainee being provided blank paper per step 10. This method begins with a blank paper to involve the trainees immediately in a “hand's on” demonstration of the elements of a planned writing, making the method interactive even at the Modeling Stage. This feature of this method helps to eliminate the initial fear in a writer by focusing the mind of the trainee on the elements of a plan rather than on the quandary of how to commence. Thus, trainees are taught to scheme and plan their narrative or expository composition before thinking about the first sentence.

In the next step, trainees learn to identify and plan out the project 20. They determine the overall concept of the narrative or expository composition in general terms, and eventually as the Stages proceed, become able to discern between detail and topic. In the Modeling Stage, this identification process is carried out primarily by the trainer. As the Stages progress, the trainees will gradually be given responsibility for identifying and making a plan.

There are four important components of identification and planning that help to define it and that are essential to proceeding with remainder of the writing process. First, it is important to identify the basic type of response to be written 21, that is, which genre it will be. The prompt determines this.

Next, the trainee is impressed with the importance of “directives” or instructions that must be followed to succeed in the writing project at step 22. A “Prompt” is a phrase or sentence that is suggestive of a general subject for the narrative or expository composition, but it is not the specific topic. For example, the sentence “write about your favorite animal” is a Prompt, while “zebras” is a specific topic that is a subset within the Prompt.

If the trainee is at the Independent Stage, he or she will have learned how to select his or her own Prompt. Prompt selection is one of the last parts of the writing process that is passed over to the trainees because of the importance of repeatedly modeling this concept to ensure understanding (see comparative chart in FIG. 1). It is this component in writing that professionals in the work force will use to select topics that will be of significance to specific target audiences.

With knowledge of the directives and Prompt in hand, the trainee is ready to select a specific topic at step 23 for the narrative or expository composition. It is significant that the topic is chosen after considering the Prompt selected or pre-selected in step 22. The selection of the topic involves a narrowing process, modeled first by the trainer in the Modeled, Shared, and Guided Stages before the trainees are permitted to make this selection on their own in the Independent Stage. At this point in the method, the training emphasizes a new concept to the trainees: captivation of the audience. By verbally thinking aloud during the Modeled Stages, the trainer will help to raise the awareness of trainees that writing can be more than words reported on a page.

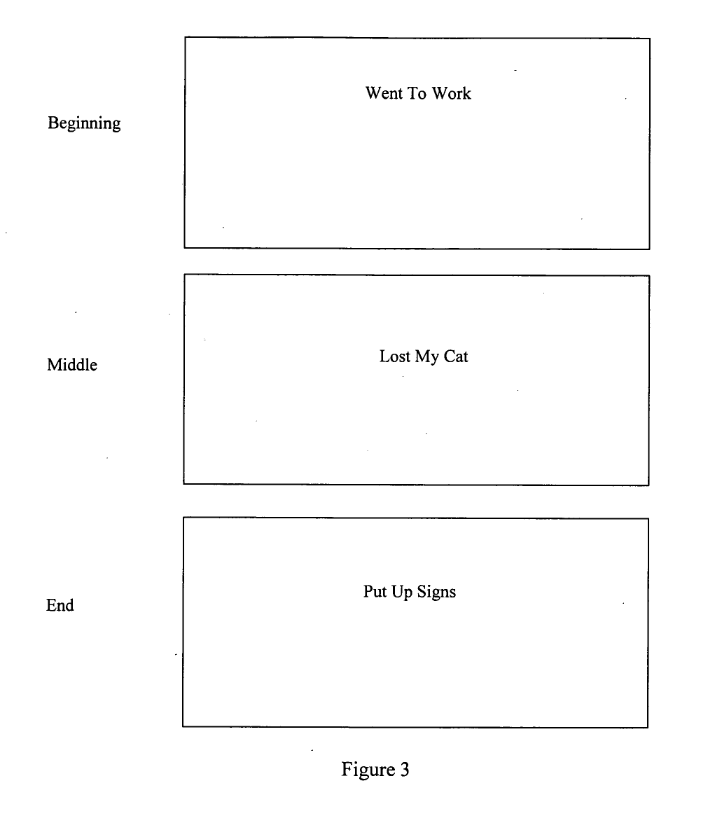

Next, the trainee will plan the parts of the narrative or expository composition at step 24 on the blank paper provided previously at step 10. The plan will consistently include the same basic elements. As trainees become more proficient at writing, sub-elements may be added or subtracted from the plan, which takes into account differing and increasing educational standards at various grade levels. Two samples of typical plans are shown in FIG. 3.

At this stage, the first step of identification and planning is completed, and the trainee can proceed to the next step, namely notation of the middle of the story at step 30. This method for narrative writing is innovative because trainees are taught to start in the middle of their particular writings, leaving the beginning and ending to be written after the primary story body has been developed. By this procedure, trainees learn to draw their audience into their stories by not revealing the main event until the audience is already interested and has begun to read the story. This method is additionally innovative because it emphasizes “notation” rather than complete sentence writing. In “notation,” the ideas are simply written in short phrases as reminders to the writer about what the sentence will cover. The concept is to create more than an outline, but not full sentences. This process renders the method more efficient and allows trainees to focus on the creation aspect of a story or report rather than losing creative momentum by becoming overly concerned with sentence structure and grammar before the story or report is developed.

Notation of the middle of the story can be divided into two sub-steps, namely selection of the event at step 31 and the addition of details at step 33. At the Modeled Stage, trainees will see and hear how a trainer selects the event based on the Prompt and directives. After the Modeled Stage, trainees are given limited time to try to select an event on their own, sharing their choice with other trainees to receive feedback. Next, they are given time to develop a few details related to the event. Eventually, trainees will begin to select the event in the same way that is modeled to them as they move through the Guided Stages. They will also come to understand the difference between the details of an event and the main ideas of the event.

The notation procedure is performed using the plan at step 24 that was written or drawn onto the blank paper provided in step 10. The plan will help trainees identify the event and details of the event that are needed to make a successful writing. This plan will contain all requirements that are part of the rubric used to score the writing, which will be revealed to the trainees before they complete their writing. In this way, trainees will gain confidence that their writing will meet the standardized testing requirements.

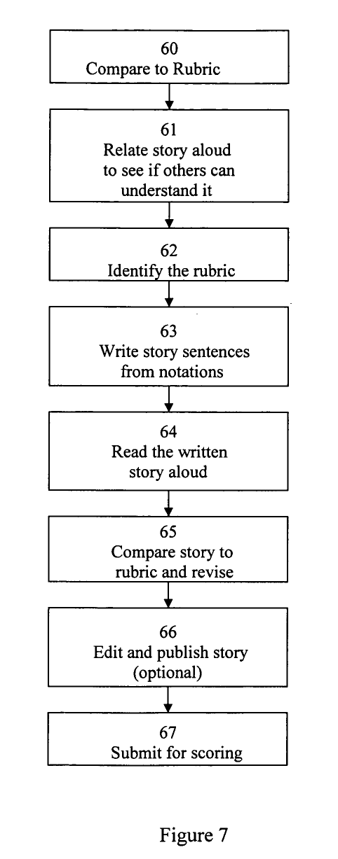

Once the middle of the story or report has been notated at step 30, the trainer will continue to notate the remainder of the writing. Specifically, the beginning is notated at step 40 and after that, the ending at step 50. Finally, the notations are turned into complete sentences, and the writing is finished, reviewed, and critiqued at step 60 (further described in FIG. 7) using a rubric that is revealed to the trainees. As with all other steps, the complete step 60 is first modeled, and then guided by the trainer.

Referring to FIGS. 3 to 5, templates are displayed to show preferred embodiments of the writing plan that are used during the process described in FIG. 2. At the beginning of the process, the trainer and the trainees all start with blank boards or papers. In a column on the left side of the blank paper or board, the trainer will write the three words “Beginning” “Middle” and “End” and will instruct the trainees to do the same on their individual papers.

The other items placed on the board or paper are discretionary, depending on the grade level of the trainees as well as on the choice of symbols by the trainer and the trainees. Via illustration, FIG. 3 displays the column of words on the left with a box drawn to the right of each word. The trainer will instruct the trainees to draw, and if possible write words, within these boxes to show the events of their stories. This template is particularly useful when trainees are younger or less capable of expressing themselves in written words.

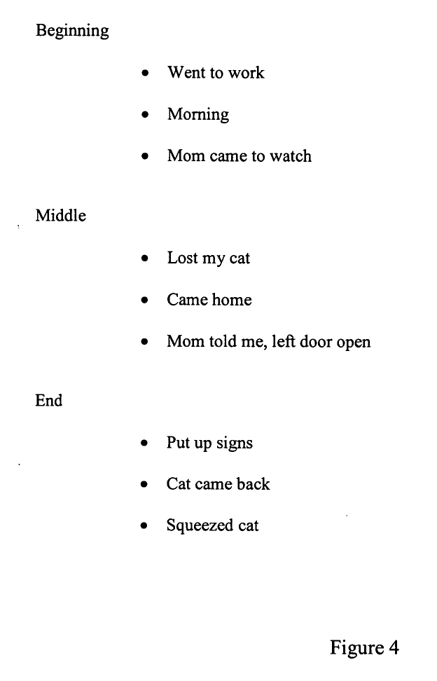

FIG. 4 demonstrates a template that would be introduced to trainees who can write, and who have progressed in the writing learning process from stories drawn in pictures or consisting of three sentences (one for each part on the template) to stories that contain details. For these trainees, the boxes are eliminated. As trainees become more adept at the narrative writing process, the trainer can add a challenge by requiring the trainees to include details related to each part. The visual representation used on the paper or board are the dots placed in a column beneath each related word. The trainer may start with one or two dots and may add as many dots as the trainer finds are required, depending on the rubric that is being applied to score the writing.

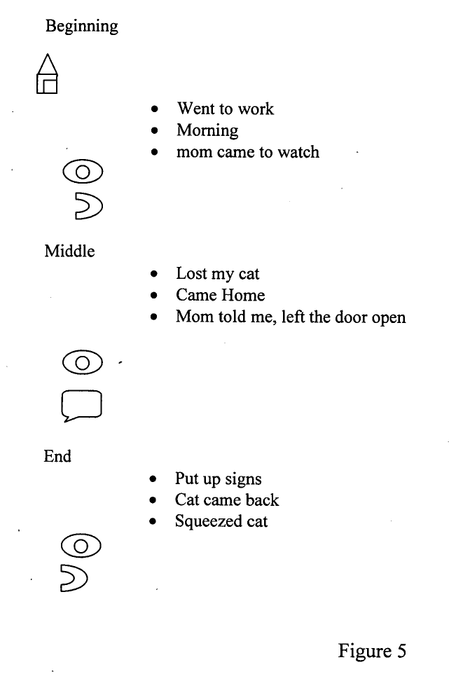

The template illustrated in FIG. 5, would be presented to trainees who are capable of writing a story or report with the basic parts and details as described above, but now are being challenged to include additional literary elements. The template is built in the same way as those shown in FIGS. 3 and 4, but the trainer instructs the trainees to add symbols to the parts. Each symbol represents a literary element. A variety of symbols can be chosen, and any plurality of symbols can be used. The symbols may be the same in each part, or they may differ as illustrated in FIG. 5. To demonstrate, FIG. 5 uses a house to represent setting of the event that is being described in the story, an eye for a visual sensory detail, an ear for an aural sensory detail, and a “callout” to represent dialogue.

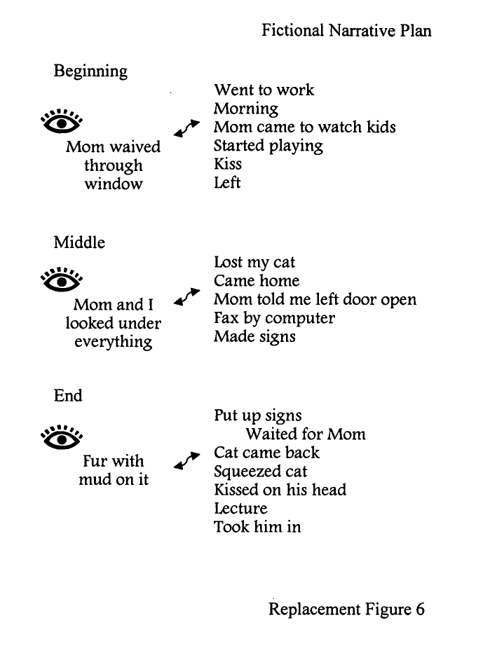

Referring to FIG. 6, a handwritten writing plan is illustrated. At the top of the illustrated page, the Prompt for the story has been written, which is helpful for reference to the writer. However, the Prompt usually is not included, in order to allow more room on the page for notations. The illustrated page shows the basic plan parts of Beginning, Middle, and End in the left column of the page. Each of these parts has been notated, starting with the middle, then the beginning, and finally the end. A literary element has been added to each part, in this case a visual one.

The flow chart in FIG. 7 displays the steps for comparison of the rubric, which is the final stage in the writing process by the trainee. This is step 60 in FIG. 2. This stage consists of several substeps that are intended to educate a trainee in the art of critical review and analysis of a narrative.

An important and unique substep for trainees is the first one, in which the trainee relates the story to another person using the notated writing plan at substep 61. The purpose of this substep is to give the trainee objective constructive criticism about the planned story before the entire story is written, allowing for revisions and clarifications before sentence writing can begin. This critique is accomplished by reading the story aloud, preferably to another trainee. By reading the narrative or expository composition aloud to another person, the writer can determine whether that person is able to understand the story and is interested in it. A story that can be understood is one in which the elements of the story flow logically one after the other, in other words, the elements have logical connections. The logical connections will most apparent when the story is read aloud to someone who has never heard it before. This substep is an exercise that educates trainees in the importance of communication skills, including skills of listening, of constructive criticism, and of discerning another's comprehension. If comprehension is not forthcoming, the trainee will make corrections based on the listener's comments.

The next substep 62 involves identifying the rubric, or scoring system, that is being applied to the narrative or expository composition so that the trainee can review the writing plan to determine whether all requirements have been met for scoring purposes. This substep is also a unique and highly significant component of this method. For narrative and expository writing, it is essential to the success and confidence of the trainee that they know the scoring requirements before they spend significant time and effort in finishing the writing. A trainee who is told what “success” means in terms of receiving a passing score will gain confidence in the writing process. The rubric is provided to the trainee by an external source, usually the trainer who has identified the educational standards required for the grade level, and the trainee will then review his or her own writing plan to ensure that all of the required elements are present.

In substep 63, the trainee is finally allowed to begin developing sentences from the writing plan notations. As illustrated in FIG. 1, the development of sentences is modeled by the trainer, and then trainees write. Often included in this substep is a review of grammar and writing styles appropriate to the grade level. To illustrate, a trainer who is modeling might remind students that the sentences start with different words, that topic and transitional sentences need to be used where appropriate, and that rules of grammar apply.

After developing the sentences, a trainee is required in substep 64 to read his or her story aloud to another person. This step has similar purposes to substep 61, except that the trainee is now reading sentences instead of telling the story from the notations in the writing plan. At this point in the method, the story should be close to complete and should be easy for the listener to follow.

A second comparison to the rubric is made in substep 65 to be certain that the scoring requirements have been met after the sentences have been written. Final revisions are then made.

An optional substep 66 involves editing and publishing the writing. This substep is optional because it is not intended to become a focus of this method. It is possible to spend a lot of time in perfecting a narrative or composition, rewriting it for penmanship, or otherwise enhancing the writing, but the primary purpose of this method is to teach how to create a logical, interesting, and successful writing, not how to publish a letter-perfect composition. A narrative or expository composition is published by putting it on display to a person other than the writer. Publishing may include a special classroom newsletter, compiling a book of one trainee's writings or the writings of a group of trainees, or simply putting the writing on a board display.

In the final substep 67, the trainee submits the writing to the trainer for scoring. The writing is scored by the trainer using the rubric that has been identified in substep 63.

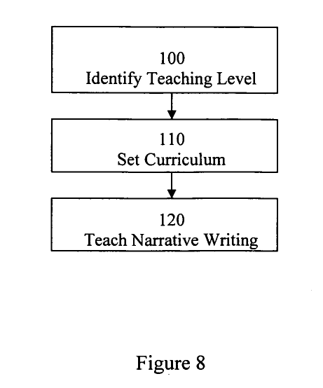

Referring to FIG. 8, this flow chart shows the Teacher Component of the method of the current invention. This Component is essential to the entire method because it involves development of the plan and curriculum for the Student Component. Regardless of whether the trainees are grade school students, high school students, or adult teachers, the trainer must complete the Teacher Component before the Student Component, described in FIGS. 1 through 7, can commence.

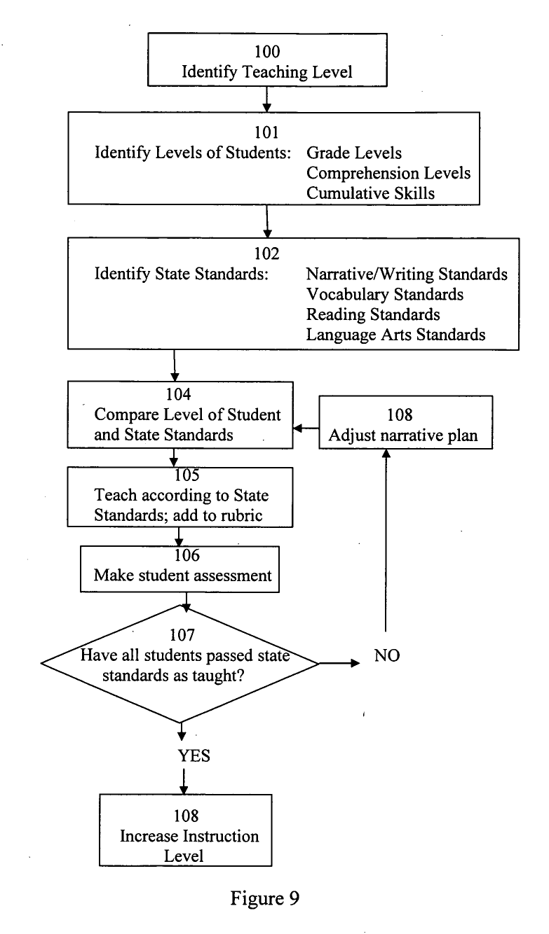

The first step in the Teacher Component of this method is to identify the level of the teaching at step 100. If grade school students are in first grade, they may not have been experienced this method previously; and so adjustments to the method will be needed to operate at the most basic level. If middle school students are being taught, some of the skills should already have been learned in prior grades, and so the method can be made more challenging. Similarly, if teachers are being trained, this method can be adapted for teachers who have never experienced it before as compared to teachers who have been exposed to the method but are seeking to improve its use. Step 100 has a number of substeps, and these are further described in FIG. 9 subsequently.

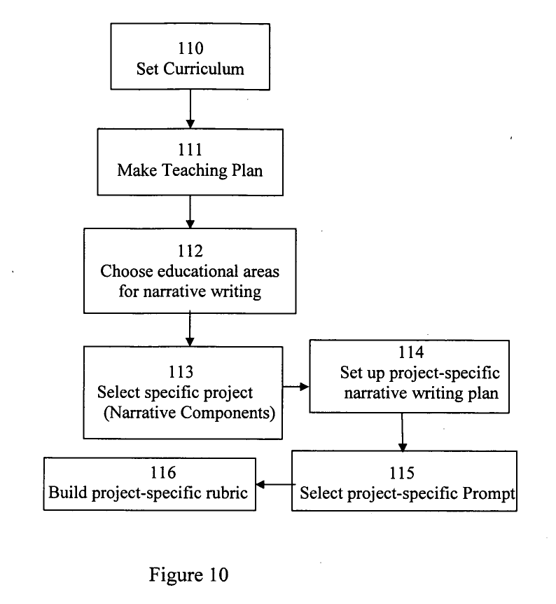

In Step 110, the trainer determines the curriculum to use to teach narrative and expository writing. The selection will depend on what the trainer has learned during the evaluation conducted in Step 100. That is, the curriculum must be developed to match the level of the trainee. During this Step, the trainer will set up lesson plans that reflect the level of the trainee and that will incorporate and emphasize the standards that the trainee is expected to achieve. This Step 100 breaks down into several substeps, and these are further described in FIG. 10, subsequently.

Teaching the trainees begins at Step 120, after the planning and development has been completed in the prior steps. The teaching is accomplished in the stages shown in FIG. 1, previously. Thus, the trainer will begin teaching by modeling the narrative and expository writing method of the current invention. The teaching method is depicted in FIG. 2.

Referring to FIG. 9, the flowchart seen therein illustrates the sub-components of Step 100 previously described in FIG. 8. At this Step 100, the trainee is assumed to be a school student. The trainer identifies the level of the teaching by evaluating at substep 101 the student's grade level, comprehension level, and cumulative skill based on the information known about the student from the student's education records. Thus, this substep 101 involves preparation prior to and in anticipation of the trainer meeting the student. Similar preparation is made in evaluating teacher trainees for a training session on the use of this method, although it is assumed that credentialed teacher trainees will have previously met educational state standards. Therefore, the preliminary preparation will focus on the experience and education shown in the teacher trainee's training application.

The trainer must additionally identify the standards required by the state education boards and other similar authorities that set the standards for passing various grade levels 102. This substep involves obtaining and reviewing state standard manuals or other similar data compilations that set writing standards, vocabulary standards, reading standards, and language arts standards. If the trainees are school students, the trainer should become familiar with the state standards not only of the assigned grade level, but also of the immediately prior and immediately succeeding grade levels. If the trainees are teachers who will be teaching school students, the trainer should become familiar with the grade levels to which the teachers are assigned so that the trainer can make the training applicable to the classroom level.

Once the standards are identified 102, the trainer will need to do an assessment of the student's educational level in comparison to the State Standards 104, and then teaching by the trainer should be in agreement with the State Standards 105. The trainer may add components to the rubric as preferred once the State Standards are mastered by the students 105.

As projects are completed, it is essential that the trainer assess the results 106 to determine whether the students have passed the minimum State Standards 107. If teacher trainers are being taught, a similar evaluation is performed to ensure that the teacher trainers comprehend the concepts and application of the method. If standards have not been met 107, the trainer may need to adjust the narrative plan 108 and cycle back through the teaching and evaluation steps 104 through 106. When standards have been met, the trainer may proceed to a new instructional level 108. For student trainees, this same assessment should be repeated at the end of the school year, allowing the assessment to be passed on to the teacher who will be instructing at the next year's grade level.

FIG. 10 is a flowchart displaying the sub-components of Step 110 described in FIG. 8 previously. At Step 110 of this method, the trainer sets the curriculum that will be used to train the trainees in narrative and expository writing.

The first substep 111 is to make a teaching plan that incorporates narrative and expository writing. This plan will reflect the grade level of the trainees, their comprehension and skill level, and the State Standards that have previously been determined in the assessment completed at Step 100 as described in FIG. 8. The Teaching Plan schedules how much time is will be spent on writing, reading, narrative and expository writing, and other required or elective subjects. It also identifies cross-over projects, in which a subject can be integrated into a narrative or expository writing exercise. The Teaching Plan establishes the goals for the training period, whether for a seminar or workshop for teachers or a school year for grade school students.

Substep 112 requires focused preparation, based on the Teaching Plan developed in substep 111. At substep 112, the trainer develops the specific educational areas where the narrative writing method will be employed.

From the list of the specific educational areas developed in sub-component 112, the trainer next selects a specific project or assignment 113. This sub-component involves further planning by the trainer, who needs to determine the specific literary elements that need to be included in the narrative or expository writing assignment and set the writing plan. This determination is, again, based on the assessment performed earlier in Step 100 of the trainee level and the state standards. In addition to reflecting both of said assessment results, the literary elements should be planned to increase as students become more proficient in writing. If this increase is planned at the start of the training program, the trainer will find that the additional elements are easy to transition into the training and will be used in a more logical and less repetitive progression than if they are selected from time to time during the training.

The trainer must next create blank project-specific narrative writing plans 114, as illustrated in FIGS. 3 through 6, select a project-specific Prompt 115, and build a project-specific rubric 116 that will be applied to the specific writing project. A new rubric should be made for each new writing assignment or project. A rubric is the scoring matrix used to evaluate the writings of the trainees. Initially, rubrics tend to be simple, consisting of making sure that there is a beginning, middle, and ending to each story. The rubric should grow in complexity as trainees become more proficient in writing. The end-of-the-year goal is to have the rubric aligned with the local district or state standard-based rubric.

The rubric will be revealed to the trainees during the training process (see FIGS. 2 and 7), and therefore it should be developed in such a way that it can be understood by the trainees. By allowing the trainees access to the scoring rubric, they will have confidence in meeting the requirements of story and report writing. Once the rubric is built, the trainer is ready to begin instruction of the writing assignment (the last step in FIG. 8). During the course of a training period, whether a workshop or a school year, substeps 113 through 116 will be repeated for each assignment taught.

When a trainer becomes more proficient in this method of writing, the trainer can begin training others who are in a position to train trainees. This method yields more successful results if it is consistently applied across grade school levels as students move from Kindergarten through high school, and therefore a teacher who prefers this method of writing should present the concept to school administration and should assist other teachers within the school and district to implement the method in other classrooms. The method can be adapted for students in English as Second Language (ESL) programs, and it can be taught to high school and even adult students. The more exposure students have to this method, the more proficient they will become in writing successful, captivating, and logical narratives and expository compositions.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. A method for instruction of writing, comprising
oral and written instructions in four training stages that include modeled writing from a trainer, shared writing, guided writing, and independent writing by trainees;
writing plans based on trainee grade, comprehension, and skill levels in combination with accepted educational standards; and
rubrics for scoring said writings, said rubrics being constructed to be provided to said trainees for purposes of self-evaluation of said writing.

2. The method of claim 1, further comprising the following substeps within each training stage:
Setting the prompt;
Planning the writing;
Writing the material;
Revising the written material; and,
Monitoring the process.

3. The method of claim 1, further comprising the use of context-specific icons to represent each section of the writing.

4. The method of claim 1, further comprising the publication of the written story.

5. The method of claim 1, further comprising a Student component for use by a teacher-trainer teaching student-trainees to write, said component comprising the training steps of:
Modeled Training, wherein the teacher-trainee demonstrates the writing process to the student-trainees;
Shared Training, wherein the teacher-trainer and the student-trainees both actively participate in the writing process;
Guided Training, wherein the teacher-trainer assists while the student-trainees create their own writings using said writing process;
Independent Training, wherein the teacher-trainee creates a writing with minimal assistance from the teacher-trainer.

6. The method of claim 5, wherein said writing process comprises the steps of:
Identification of the Writing Project;
Identifying and responding to directives;
Selecting a specific topic for the narrative or expository compositon;
Creating a writing plan;
Notation of the middle of the story;
Adding details;
Notation of the beginning of the story, also known as setting the context for action;
Notation of the end of the story;
Completion of the writing project, and,
Review of the writing project.

7. The method of claim 5, wherein said review further comprises the steps of:
Relating the story aloud to listeners to check comprehension;
Identifying the rubric;
Writing sentences from the notations;
Reading the writing aloud to listeners;
Comparing the writing to the rubric and revising for consistency; and,
Submitting the written story to the trainer for scoring.

8. The method of claim 1, further comprising a Teacher component for use by a teacher-trainer teaching teacher-trainees to write, said component comprising the training steps of:
Modeled Training, wherein the teacher-trainee demonstrates the writing process as if the teacher-trainees are student-trainees;
Shared Training, wherein the teacher-trainer and the teacher-trainees both actively participate in the writing process as if the teacher-trainees are student-trainees;
Guided Training, wherein the teacher-trainer assists while the student-trainees create their own writings using said writing process as if the teacher-trainees are student-trainees;
Independent Training, wherein the teacher-trainee creates a writing with minimal assistance from the teacher-trainer as if the teacher-trainees are student-trainees;
Curriculum planning, wherein the teacher-trainee instructs the teacher-trainees on constructing and implementing the writing process for student-trainees.

9. The method of claim 8, wherein the curriculum planning component consists of the steps of:
a. Identifying the teaching level;
b. Identifying the level of trainees;
c. Identifying standards set by the State;
d. Comparing trainee levels and State standards;
e. Set level of instruction accordingly;
f. Set curriculum;
g. Make teaching plan;
h. Choose topics;
i. Select a specific topic for use as a model;
j. Set writing plan;
k. Select a prompt and test said prompt; and,
l. Build a rubric with trainees.

10. The method of claim 1, as used for instruction of narrative writing.

11. The method of claim 1, as used for instruction of expository writing.

12. The method of claim 1, as used for instruction of writing responses to literature.

13. A method for instruction of writing, comprising
oral and written instructions in four training stages that include modeled writing from a trainer, shared writing, guided writing, and independent writing by trainees;
writing plans based on trainee grade, comprehension, and skill levels in combination with current government educational standards; and
rubrics for scoring said writings, said rubrics being constructed to be provided to said trainees for purposes of self-evaluation of said writing.

14. The method of claim 13, further comprising the following substeps within each training stage:
Setting the prompt;
Planning the writing;
Writing the material;
Revising the written material; and,
Monitoring the process.

15. The method of claim 13, further comprising the use of context-specific icons to represent each section of the writing.

16. The method of claim 13, further comprising a Student component for use by a teacher-trainer teaching student-trainees to write, said component comprising the training steps of:
Modeled Training, wherein the teacher-trainee demonstrates the writing process to the student-trainees;
Shared Training, wherein the teacher-trainer and the student-trainees both actively participate in the writing process;
Guided Training, wherein the teacher-trainer assists while the student-trainees create their own writings using said writing process; and
Independent Training, wherein the teacher-trainee creates a writing with minimal assistance from the teacher-trainer.

17. The method of claim 17, wherein said writing process comprises the steps of:
Identification of the Writing Project;
Identifying and responding to directives;
Selecting a specific topic for the narrative or expository compositon;
Creating a writing plan;
Notation of the middle of the story;
Adding details;
Notation of the beginning of the story, also known as setting the context for action;
Notation of the end of the story;
Completion of the writing project, and,
Review of the writing project.

18. The method of claim 17, wherein said review further comprises the steps of:
Relating the story aloud to listeners to check comprehension;
Identifying the rubric;
Writing sentences from the notations;
Reading the writing aloud to listeners;
Comparing the writing to the rubric and revising for consistency; and,
Submitting the written story to the trainer for scoring.

19. The method of claim 13, further comprising a Teacher component for use by a teacher-trainer teaching teacher-trainees to write, said component comprising the training steps of:
Modeled Training, wherein the teacher-trainee demonstrates the writing process as if the teacher-trainees are student-trainees;
Shared Training, wherein the teacher-trainer and the teacher-trainees both actively participate in the writing process as if the teacher-trainees are student-trainees;
Guided Training, wherein the teacher-trainer assists while the student-trainees create their own writings using said writing process as if the teacher-trainees are student-trainees;
Independent Training, wherein the teacher-trainee creates a writing with minimal assistance from the teacher-trainer as if the teacher-trainees are student-trainees;
Curriculum planning, wherein the teacher-trainee instructs the teacher-trainees on constructing and implementing the writing process for student-trainees.

20. The method of claim 20, wherein the curriculum planning component consists of the steps of:
a. Identifying the teaching level;
b. Identifying the level of trainees;
c. Identifying standards set by the State;
d. Comparing trainee levels and State standards;
e. Set level of instruction accordingly;
f. Set curriculum;
g. Make teaching plan;
h. Choose topics;
i. Select a specific topic for use as a model;
j. Set writing plan;
k. Select a prompt and test said prompt; and,
l. Build a rubric with trainees.
